(19) United States
(12) Patent Application Publication
(10) Pub. No.: US 2022/0344840 A1
(43) Pub. Date: Oct. 27, 2022

(54) DUAL HOOK AND EYE FASTENER

(71) Applicant: BowBunny LLC, State College, PA (US)

(72) Inventor: Garrett Anderson Barch, State College, PA (US)

(21) Appl. No.: 17/727,555

(22) Filed: Apr. 22, 2022

Related U.S. Application Data
(60) Provisional application No. 63/178,291, filed on Apr. 22, 2021.

(51) Int. Cl. H01R 4/14; F21V 23/06; F21V 19/00; H01R 11/01

(52) U.S. Cl. CPC H01R 4/14; F21V 23/06; F21V 19/0025; H01R 11/01; F21Y 2115/10

(57) ABSTRACT

The present invention provides a dual hook and eye fastener. The fastener includes a first end and a second end opposite the first end. A first eye and a second eye are located at the first end. The first eye is located farther from the second end than the second eye. A first hook and a second hook are located at the second end. The first hook is located farther from the first end than the second hook.

### CROSS-REFERENCE TO RELATED APPLICATION

This application claims the benefit of U.S. Provisional Patent Application No. 63/178,291 filed Apr. 22, 2021, which is incorporated herein by reference.

### FIELD OF THE INVENTION

The present invention relates to fasteners, and more particularly fasteners with dual hooks and dual eyes.

### BACKGROUND INFORMATION

Fasteners are used in a variety of applications, including the securing of electronics. Advances in low power and small-sized electronics, such as Light-Emitting Diodes (LEDs), have resulted in increased portability of the electronics. However, in order to power these electronics, it is often still necessary to either plug an electronic into a socket, which can be removed with minimal force, or use more permanent methods, such as solder, glue, or tape, to connect the power source to the electronic, which makes disconnecting the electronic difficult. There is a need to provide a fastener that can provide detachable power to an electronic while still providing enough structure to prevent accidental detachment.

### SUMMARY OF THE INVENTION

The present invention provides a dual hook and eye fastener. The fastener includes a first end and a second end opposite the first end. A first eye and a second eye are located at the first end. The first eye is located farther from the second end than the second eye. A first hook and a second hook are located at the second end. The first hook is located farther from the first end than the second hook.

An aspect of the present invention is to provide a dual hook and eye fastener comprising a first end and a second end opposite the first end. The first eye and a second eye are located adjacent the first end. The first eye is located farther from the second end than the second eye. A first hook and a second hook are located adjacent the second end. The first hook is located farther from the first end than the second hook.

Another aspect of the present invention is to provide A chain of dual hook and eye fasteners. The chain comprises a first dual hook and eye fastener and a second dual hook and eye fastener. Each of the first dual hook and eye fastener and the second dual hook and eye fastener comprises a first end and a second end opposite the first end. A first eye and a second eye are located at the first end. The first eye is located farther from the second end than the second eye. A first hook and a second hook are located at the second end. The first hook is located farther from the first end than the second hook. The first end of the first dual hook and eye fastener is secured to the second end of the second dual hook and eye fastener.

These and other aspects of the present invention will be more apparent from the following description.

### BRIEF DESCRIPTION OF THE DRAWINGS

FIG. 1 is a front schematic view of a dual hook and eye fastener in accordance with an embodiment of the present invention.

FIG. 2 is a schematic view of the dual hook and eye fastener of FIG. 1.

FIG. 3 is a front schematic view of a chain of dual hook and eye fasteners of FIG. 1.

FIG. 4 is a front schematic view of an electronic unit in accordance with an embodiment of the present invention.

FIG. 5 is a front view of a dual hook and eye fastener without an electronic unit in accordance with an embodiment of the present invention.

FIG. 6 is a side view of the dual hook and eye fastener of FIG. 4.

FIG. 7 is a top view of the dual hook and eye fastener of FIG. 4.

FIG. 8 is a bottom view of the dual hook and eye fastener of FIG. 4.

FIG. 9 is a chain of the dual hook and eye fastener of FIG. 4.

FIG. 10 is a front view of a dual hook and eye fastener with an electronic unit in accordance with an embodiment of the present invention.

FIG. 11 is a side view of the dual hook and eye fastener of FIG. 10.

FIG. 12 is a top view of the dual hook and eye fastener of FIG. 10.

FIG. 13 is a bottom view of the dual hook and eye fastener of FIG. 10.

FIG. 14 is a chain of the dual hook and eye fastener of FIG. 10.

FIG. 15 is a flow chart of a method of making a dual hook and eye fastener in accordance with an embodiment of the present invention.

FIG. 16 is a step in the method of making a dual hook and eye fastener of FIG. 15.

FIG. 17 is a further step in the method of making a dual hook and eye fastener of FIG. 15.

FIG. 18 is another step in the method of making a dual hook and eye fastener of FIG. 15.

FIG. 19 is a further step in the method of making a dual hook and eye fastener of FIG. 15.

FIG. 20 is another step in the method of making a dual hook and eye fastener of FIG. 15.

FIG. 21 is a further step in the method of making a dual hook and eye fastener of FIG. 15.

FIG. 22 is another step in the method of making a dual hook and eye fastener of FIG. 15.

FIG. 23 is a further step in the method of making a dual hook and eye fastener of FIG. 15.

FIG. 24 is another step in the method of making a dual hook and eye fastener of FIG. 15.

FIG. 25 is a further step in the method of making a dual hook and eye fastener of FIG. 15.

FIG. 26 is another step in the method of making a dual hook and eye fastener of FIG. 15.

FIG. 27 is a further step in the method of making a dual hook and eye fastener of FIG. 15.

FIG. 28 is another step in the method of making a dual hook and eye fastener of FIG. 15.

FIG. 29 is a front schematic view of a dual hook and eye fastener in accordance with an embodiment of the present invention.

FIG. 30 is a front schematic view of a chain of dual hook and eye fasteners of FIG. 29.

FIG. 31 is a front schematic view of an electronic unit secured to the dual hook and eye fastener of FIG. 29.

FIG. 32 is a schematic view of an electronic unit in accordance with an embodiment of the present invention.

FIG. 33 is a schematic view of a chain of electronic units of FIG. 32.

### DETAILED DESCRIPTION

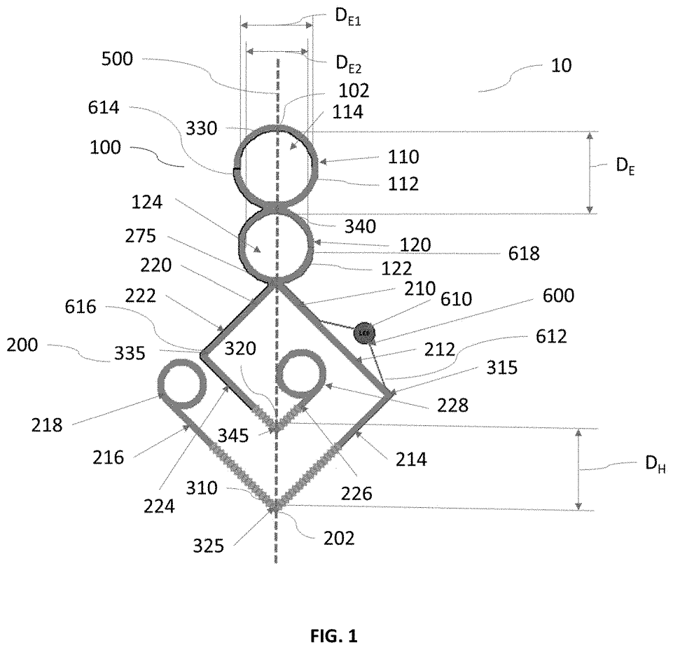

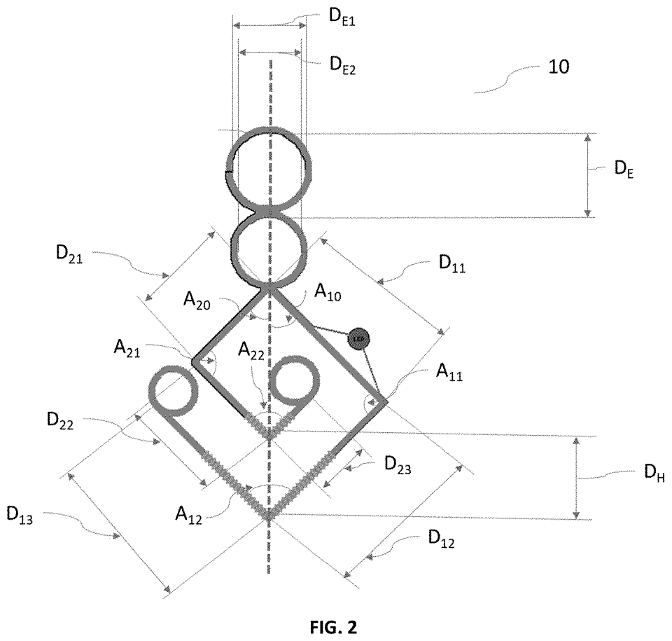

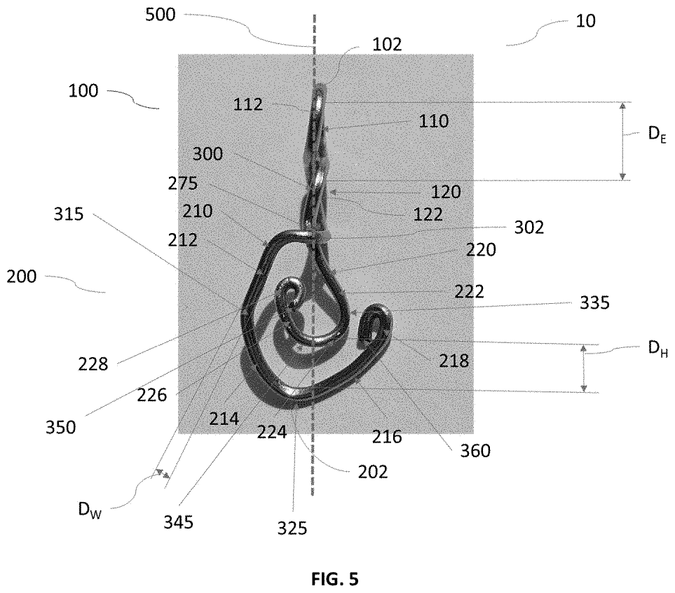

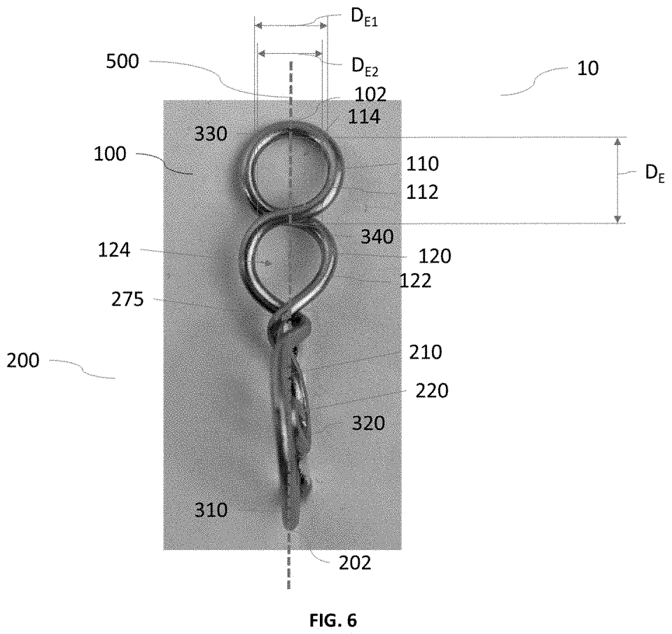

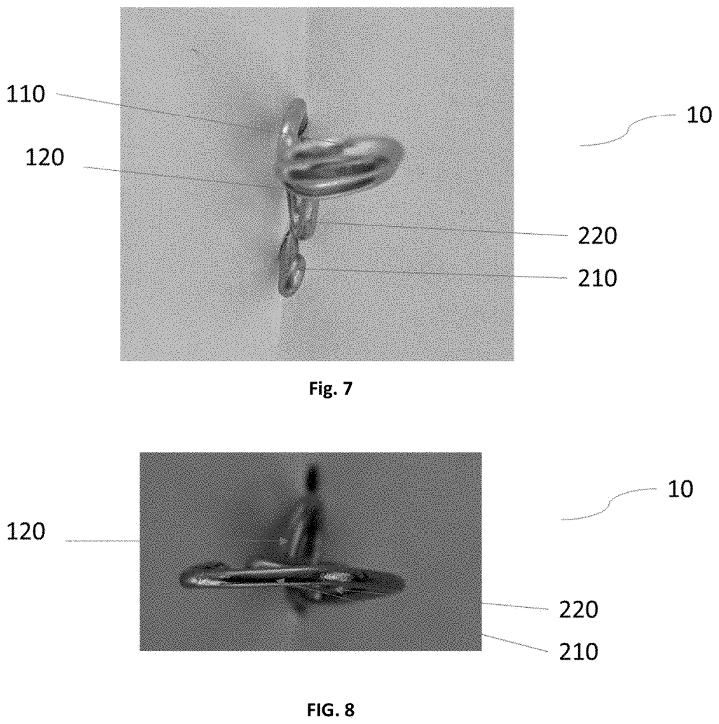

Shown in FIGS. 1-3, 5-9 and 29 is a dual hook and eye fastener 10. FIGS. 1-3 and 29 show partially schematic views of the dual hook and eye fastener 10, while FIGS. 5-9 show an example dual hook and eye fastener 10 according to non-limiting embodiments. As used herein, the term “dual” when used to refer to the fastener 10 means that the fastener 10 comprises at least two hooks and at least two eyes, and includes embodiments having more than two hooks and/or eyes, e.g., three or more hooks and/or eyes. The fasteners 10 are structured and arranged to allow one fastener 10 to be secured to a second fastener 10 without the use of soldering, gluing, or taping, while still allowing a rigid connection that is unlikely to be disconnected accidentally. This allows the addition or removal of fasteners 10 to be completed quickly and simply while still providing rigidity.

The dual hook and eye fastener 10 includes a first end 100 and a second end 200, the first end 100 being opposite the second end 200. The first end 100 may include a double female connection, for example two eyes 110, 120. The first eye 110 may be located at a first tip 102 of the first end 100 the first eye 110 may be circular in shape. The first tip 102 may be the point of the first end 100 that is located farthest from the second end 200.

The first eye 110 may be centered on a center axis 500. The first eye 110 includes a first eye perimeter 112 surrounding a first eye opening 114. The first eye 110 may be circular in shape, oval in shape, or some other geometric shape.

The first eye 110 may have an inner diameter D_{E1} that is at least 2 mm, for example, at least 3 mm, or at least 5 mm. The first eye inner diameter D_{E1} may be the diameter of the first eye opening 114. The first eye 110 may have an inner diameter D_{E1} that is at most 10 mm, for example, at most 7 mm, or at most 5 mm. The inner diameter of the first eye D_{E1} may range from 2 mm to 10 mm, for example, from 3 mm to 7 mm.

The second eye 120 may be adjacent to the first eye 110 in the first end 100. The second eye 120 includes a second eye perimeter 122 surrounding a second eye opening 124. The second eye 120 may be circular in shape, oval in shape, or some other geometric shape. The second eye 120 may be the same geometric shape as the first eye 110.

The second eye 120 may contact the first eye 110 such that second eye perimeter 122 comes in contact with a portion of the first eye 110. The second eye 120 may be located farther from the first tip 102 of the first end 100 than the first eye 110. The second eye 120 may be centered on the center axis 500 such that first eye 110 and the second eye 120 are arranged parallel to each other. The second eye 120 and first eye 110 may be oriented in the same plane.

The second eye 120 may be the same size as the first eye 110. In some non-limiting embodiments or aspects, the inner diameter D_{E2} of the second eye 120 may be less than the inner diameter D_{E1} of the first eye 110. The second eye inner diameter D_{E2} may be the diameter of the second eye opening 124. The second eye 120 may have an inner diameter D_{E2} that is at least 2 mm, for example, at least 3 mm, or at least 4 mm. The second eye 120 may have an inner diameter D_{E2} that is at most 10 mm, for example, at most 7 mm, or at most 4 mm. The inner diameter of the second eye D_{E2} may range from 2 mm to 10 mm, for example, from 3 mm to 7 mm.

The second end 200 may include a double male connection, for example, two hooks 210, 220. The first hook 210 and the second hook 220 may start at a central point 275. The central point 275 may be located between the first end 100 and the second end 200. The central point 275 may connect to the second eye 120. The central point 275 may be centered on the central axis 500.

The first hook 210 and the second hook 220 may be structured and arranged to extend from the central point 275 in a general hook or “J” shape, such that each hook 210, 220 initially extends away from the first end 100 before changing direction and extending towards the first end 100. The first hook 210 and the second hook 220 may be oriented in different directions, for example, the first hook 210 may be oriented such that the hook shape is pointed in the opposite direction as the hook shape of the second hook 220, or the first hook 210 and the second hook 220 may be oriented in mirrored directions about the central axis 500 such that the first hook 210 may initially extend in an opposite direction than the second hook 220. The first hook 210 and the second hook 220 may be oriented in the same plane. The second hook 220 may be nested inside of the first hook 210 such that the first hook 210 surrounds at least a portion of the second hook 220.

The first hook 210 may initially extend from the central point 275 away from the first end 100 and away from the central axis 500 forming a first hook first segment 212. The first hook first segment 212 may initially extend at a first hook initial angle A₁₀ of at least 15° from the central axis 500, for example, at least 30° or at least 45°. The first hook first segment 212 may initially extend at a first hook initial angle A₁₀ of at most 75° from the central axis 500, for example, at most 60° or at most 45°. The first hook first segment 212 may initially extend at a first hook initial angle A₁₀ ranging from 15° to 75° from the central axis 500, for example from 30° to 60°. The first hook first segment 212 may be straight or may be curved.

The first hook first segment 212 may have a first hook first segment length D₁₁ that is at least 5 mm long, for example, at least 7 mm long or at least 10 mm long. The first hook first segment length D₁₁ may be at most 20 mm long, for example, at most 17 mm long or at most 14 mm long. The first hook first segment length D₁₁ may range from 5 to 20 mm long, for example, from 7 mm to 17 mm long, or from 10 mm to 14 mm long.

After the first hook first segment 212, the first hook 210 may then undergo a first hook first bend 315 such that the first hook 210 continues moving away from the first end 100, but begins moving towards the central axis 500, forming a first hook second segment 214. The first hook second segment 224 may have a first hook second segment length D₁₂ that is at least 5 mm long, for example, at least 7 mm long or at least 10 mm long. The first hook second segment length D₁₂ may be at most 20 mm long, for example, at most 17 mm long or at most 14 mm long. The first hook second segment length D₁₂ may range from 5 to 20 mm long, for example, from 7 mm to 17 mm long, or from 10 mm to 14 mm long. The first hook second segment 214 may be straight or may be curved.

The first hook first bend 315 may be angled at a first hook first bend angle A₁₁ of at least 60°, for example, at least 75°, or at least 90°. The first hook first bend angle A₁₁ may be at most 120°, for example, at most 105°, or at most 90°. The first hook first bend angle A₁₁ may range from 60° to 120°, for example, from 75° to 105°.

After the first hook second segment 214, the first hook 210 may undergo a first hook second bend 325 such that the first hook 210 moves away from the central axis 500 and begins moving towards the first end 100, forming the first hook third segment 216. The first hook third segment 226 may have a first hook third segment length D₁₃ that is at least 5 mm long, for example, at least 7 mm long or at least 10 mm long. The first hook third segment length D₁₃ may be at most 20 mm long, for example, at most 17 mm long or at most 14 mm long. The first hook third segment length D₁₃ may range from 5 to 20 mm long, for example, from 7 mm to 17 mm long, or from 10 mm to 14 mm long. The first hook third segment 216 may be straight or may be curved.

The first hook second bend 325 may be angled at a first hook second bend angle A₁₂ of at least 60°, for example, at least 75°, or at least 90°. The first hook second bend angle A₁₂ may be at most 120°, for example, at most 105°, or at most 90°. The first hook second bend angle A₁₂ may range from 60° to 120°, for example, from 75° to 105°.

The first hook third segment 216 may include a first hook loop 218 at the end of the first hook third segment 216. The first hook loop 218 may initially bend towards the first end 100 such that the first hook loop 218 is closer to the first end 100 than the first hook third segment 216. The first hook loop 218 may be a closed loop, such that the end of the first hook loop 218 comes in contact with the first hook 210, or an open loop, such that the end of the first hook loop 218 does not come in contact with another surface of the first hook 210. The first hook first segment 212, first hook second segment 214, first hook third segment 216, and the first hook loop 218 may be located within the same plane.

The second hook 220 may initially extend from the central point 275 away from the first end 100 and away from the central axis 500 forming a second hook first segment 222. The second hook first segment 222 may initially extend at a second hook initial angle A₂₀ of at least 15° from the central axis 500, for example, at least 30°, or at least 45°. The second hook initial angle A₂₀ may be at most 75° from the central axis 500, for example, at most 60°, or at most 45°. The second hook initial angle A₂₀ may range from 15° to 75° from the central axis 500, for example, from 30° to 60°. The second hook first segment 222 may be straight or may be curved.

The second hook first segment 222 may have a second hook first segment length D₂₁ of at least 3 mm long, for example, at least 4 mm long, or at least 5 mm long. The second hook first segment length D₂₁ may be at most 10 mm long, for example, at most 7 mm long, or at most 5 mm long. The second hook first segment length D₂₁ may range from 3 mm to 10 mm long, for example, from 4 mm to 7 mm long. The second hook first segment length D₂₁ may be shorter than the first hook first segment length D₁₁.

After the second hook first segment 222, the second hook 220 may then undergo a second hook first bend 335 such that the second hook 220 continues moving away from the first end 100, but begins moving towards the central axis 500, forming a second hook second segment 224.

The second hook second segment 224 may have a second hook second segment length D₂₂ of at least 3 mm long, for example, at least 4 mm long, or at least 5 mm long. The second hook second segment length D₂₂ may be at most 10 mm long, for example, at most 7 mm long, or at most 5 mm long. The second hook second segment length D₂₂ may range from 3 mm to 10 mm long, for example, from 4 mm to 7 mm long. The second hook second segment length D₂₂ may be shorter than the first hook second segment length D₁₂. The second hook second segment 224 may be straight or may be curved. The second hook second segment 224 may be shorter than the first hook second segment 214.

The second hook first bend 335 may be angled at a second hook first bend angle A₂₁ of least 60°, for example, at least 75°, or at least 90°. The second hook first bend angle A₂₁ may be at most 120°, for example, at most 105°, or at most 90°. The second hook first bend angle A₂₁ may range from 60° to 120°, for example, from 75° to 105°. The second hook first bend 335 may be parallel to the first hook first bend 315.

The second hook first bend 335 may be at least 0.5 mm closer to the central axis 500 than the first hook first bend 315, for example, at least 1 mm closer, or 2 mm closer. The second hook first bend 335 may be at most 5 mm closer to the central axis 500 than the first hook first bend 315, for example, at most 3 mm closer, or at most 2 mm closer. The second hook first bend 335 may range from 0.5 mm to 5 mm closer to the central axis 500 than the first hook first bend 315, for example, from 3 mm to 1 mm closer.

After the second hook second segment 224, the second hook 220 may undergo a second hook second bend 345 such that the second hook 220 moves away from the central axis 500 and begins moving towards the first end 100, forming the second hook third segment 226. The second hook second bend 345 may occur at the central axis 500. The second hook third segment 226 may have a second hook third segment length D₂₃ of at least 3 mm long, for example, at least 4 mm long, or at least 5 mm long. The second hook third segment length D₂₃ may be at most 10 mm long, for example, at most 7 mm long, or at most 5 mm long. The second hook third segment length D₂₃ may range from 3 mm to 10 mm long, for example, from 4 mm to 7 mm long. The second hook third segment length D₂₃ may be shorter than the first hook third segment length D₁₃. The second hook third segment 226 may be straight or may be curved. The second hook third segment 226 may be shorter than the first hook third segment 216.

The second hook second bend 345 may be angled at a second hook second bend angle A₂₂ of at least 60°, for example, at least 75°, or at least 90°. The second hook second bend angle A₂₂ may be at most 120°, for example, at most 105°, or at most 90°. The second hook second bend angle A₂₂ may range from 60° to 120°, for example, from 75° to 105°. The second hook second bend 345 may be parallel to the first hook second bend 325.

The second hook second bend 345 may be at least 0.5 mm closer to the first end 100 than the first hook second bend 325, for example, at least 1 mm closer, or 2 mm closer. The second hook second bend 345 may be at most 5 mm closer to the first end 100 than the first hook second bend 325, for example, at most 3 mm closer, or at most 2 mm closer. The second hook second bend 345 may range from 0.5 mm to 5 mm closer to the first end 100 than the first hook second bend 325, for example, from 3 mm to 1 mm closer.

The second hook third segment 226 may include a second hook loop 228 at the end of the second hook third segment 226. The second hook loop 228 may initially bend towards the first end 100 such that the second hook loop 228 is closer to the first end 100 than the second hook third segment 226. The second hook loop 228 may be a closed loop, such that the end of the second hook loop 228 comes in contact with the second hook 220, or an open loop, such that the end of the second hook loop 228 does not come in contact with another surface of the second hook 220. The second hook first segment 222, second hook second segment 224, second hook third segment 226, and the second hook loop 228 may be located within the same plane.

The first hook first segment 212 and/or the first hook third segment 216 may be parallel to the second hook second segment 224. The first hook second segment 214 may be parallel to the second hook first segment 222 and/or the second hook third segment 226. In some non-limiting embodiments, the first hook initial angle A₁₀ may be the same as the second hook initial angle A₂₀, or the first hook initial angle A₁₀ may be the greater than or less than the second hook initial angle A₂₀. In some non-limiting embodiments, the first hook first bend angle A₁₁ may be equal to the second hook first bend angle A₂₁, or the first hook first bend angle A₁₁ may be greater than or less than the second hook first bend angle A₂₁. In some non-limiting embodiments, the first hook second bend angle A₁₂ may be equal to the second hook second bend angle A₂₂, or the first hook second bend angle A₁₂ may be greater than or less than the second hook second bend angle A₂₂.

A second hook second bend angle A₂₂ being greater than 90°, for example 100°, may allow the first hook first segment 212 to be shorter than it would if the second hook second bend angle A₂₂ was 90°. The first hook second bend angle A₁₂ being less than 90°, for example 80° may allow for the first hook loop 218 to be closer to the central axis 500 than if the first hook second bend angle A₁₂ was 90°. Therefore, a combination of a second hook second bend angle A₂₂ being greater than 90° and a first hook second bend angle A₁₂ being less than 90°, may result in a smaller outside width of the fastener 10.

The first eye 110 and the second eye 120 of the first end 100 may form a single male connection. The first hook 210 and the second hook 220 of the second end 200 may form a single female connection. A first fastener 10 may be connected to a second fastener 10 by inserting the first end 100 of the first fastener 10 into the second end 200 of the second fastener 10. A first end 100 being inserted into the second end 200 results in the second hook 220 of the first fastener 10 being inserted into the first eye 110 of the second fastener 10, and the first hook 210 of the first fastener 10 being inserted into the second eye 120 of the second fastener 10. Therefore, inserting the first end 100 of the first fastener 10 into the second end 200 of the second fastener 10 results in a single male connection being inserted into a single female connection, while simultaneously resulting the double male connections of the first hook 210 and second hook 220 of the first fastener 10 being inserted into the double female connections of the first eye 110 and the second eye 120 of the second fastener 10.

The first end 100 and second end 200 of the fastener 10 are structured and arranged to allow a secure connection between two or more fasteners 10. Although the fasteners 10 can be connected and unconnected to each other without the use of soldering, taping, or gluing, they still maintain a connection that cannot be undone by simply pulling in a single direction to disconnect the fasteners 10. Instead, the hooks 210, 220 and eyes 110, 120 will maintain their structure and maintain the connection between the fasteners 10 if a tugging force is applied to any of the fasteners 10 in a chain. In order to disconnect a fastener 10, a user would manipulate at least one of the fasteners 10 to unhook the first hook 210 and second hook 220 of one fastener 10 from the first eye 110 and second eye 120 of a second fastener 10. The first hook loop 218 and second hook loop 228 may prevent the first hook 210 and second hook 220, respectively, of a first fastener 10 from unintentionally sliding out of the first eye 110 and second eye 120 of a second fastener 10 during movement of the fasteners 10. However, the fasteners 10 could still become disconnected through direct intentional manipulation of the fasteners 10 by a user.

In some non-limiting embodiments or aspects, the fasteners 10 may not include a first hook loop 218 or second hook loop 228. However, even without the hook loops 218, 228, disconnection of the fasteners 10 would still require movement of at least one fastener 10 in multiple directions to separate the fasteners 10, which would be unlikely to occur without user interaction.

The fastener 10 may be made by using a single wire 300. The wire 300 may include a wire first end 350 and a wire second end 360, the wire second end 360 being on the opposite side of the wire first end 350. The wire 300 may be made of steel, or any other rigid material. The wire 300 may have an outer diameter D_{W} of at least 0.0148 inch, for example, at least 0.018 inch, or at least 0.022 inch. The wire 300 may have an outer diameter D_{W} of at most 0.036 inch, for example, at most 0.028 inch, or at most 0.022 inch. The wire 300 may have a diameter D_{W} in the range from 0.0148 inch to 0.036 inch, for example, from 0.018 inch to 0.028 inch. The wire 300 may be a 20 gauge wire, 22 gauge wire, 24 gauge wire, 26 gauge wire, or 28 gauge wire.

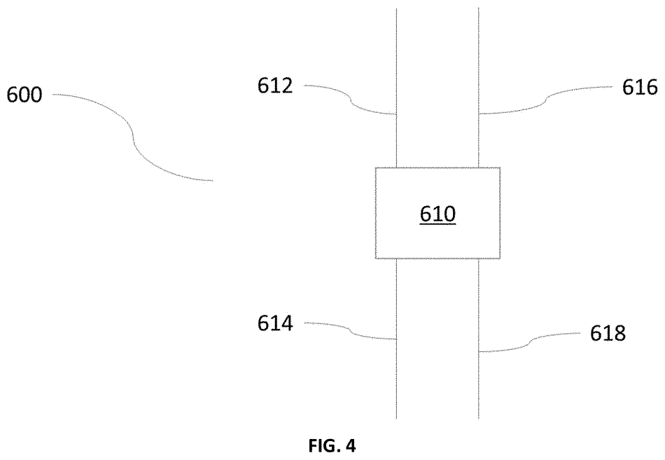

An electronic unit 600, shown in FIG. 4 may be secured to the fastener 10. The electronic unit 600 may include an LED light 610, a first anode wire 612, a second anode wire 614, a first cathode wire 616 and a second cathode wire 618. The LED light 610 may include electronic circuitry necessary to operate the LED light 610. The LED light 610 may be any suitable units known to those skilled in the art, such as commercially available units: SparkFun Electronics Model number 12021; Inspired LEDs Model number 12V-NB-BLU-12M; and NTE Electronics, INC Model number 69-28B. The anode and cathode wires 612, 614, 616, 618 are connected to the LED light 610 to provide electric flow from and to the LED light 610. The fastener 10 may be structured and arranged to be a spine of the electronic unit 600, providing rigidity to the electronic unit 600 when connecting the electronic unit 600 to a second electronic unit 600 secured to a second fastener.

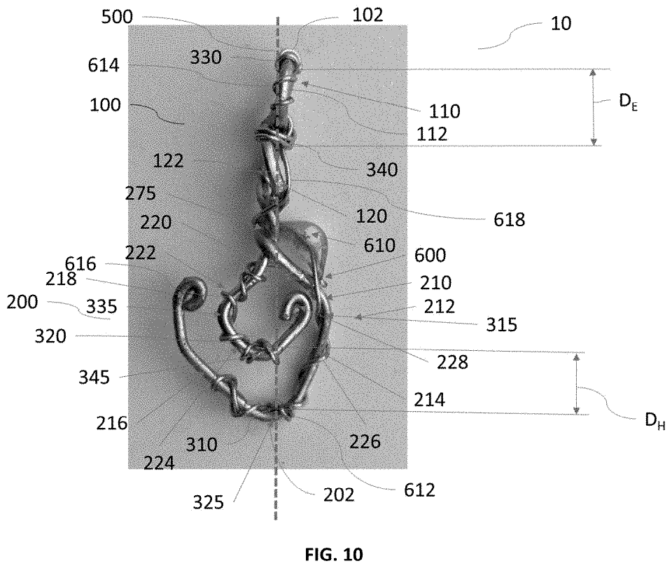

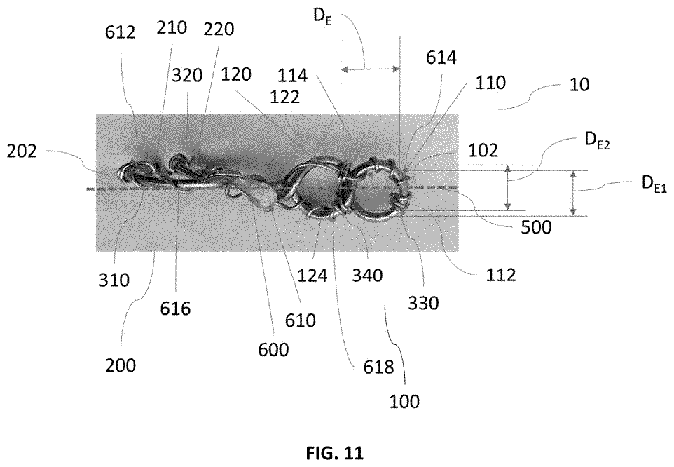

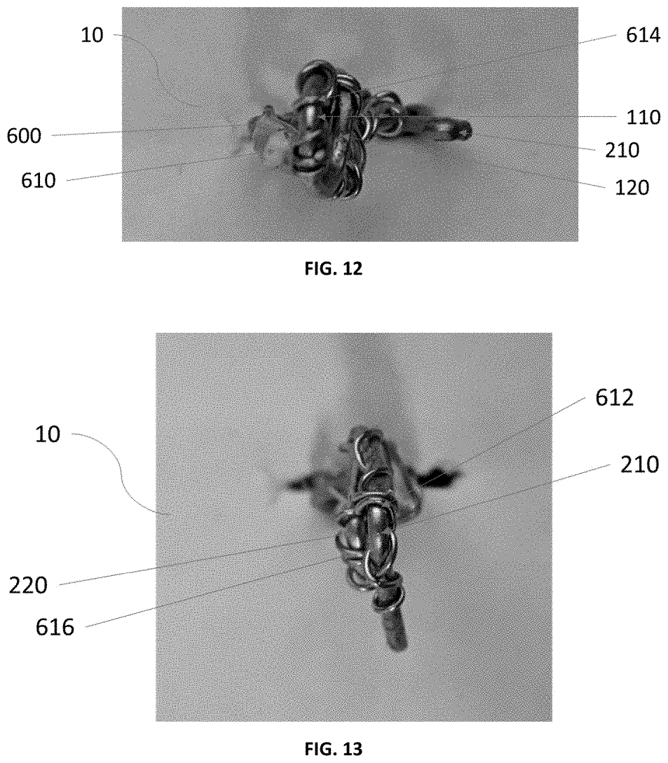

The electronic unit 600 may be secured to the fastener 10, as shown in FIGS. 1-3 and 10-14, by securing the anode and cathode wires 612, 614, 616, 618 to the first eye 110, second eye 120, first hook 210, and second hook 220. In some non-limiting embodiments, the first anode wire 612 is secured to the second hook 220, the second anode wire 614 is secured to the second eye 120, the first cathode wire 616 is secured to the first hook 210, and the second cathode with 618 is secured to the first eye 110.

In some non-limiting embodiments, the first anode wire 612 is secured to the first hook 210, the second anode wire 614 is secured to the first eye 110, the first cathode wire 616 is secured to the second hook 220, and the second cathode with 618 is secured to the second eye 120.

The use of two eyes 110, 120 and two hooks 210, 220 of the fastener 10 allows the anode wires 612, 614 to remain separated from the cathode wires 616, 618. When two or more fasteners 10 with electronic units 600 are connected to each other, the dual eye 110, 120 and dual hook 210, 220 allows two separate electrical flow paths to exist within the chain of fasteners 10, one through the anode and cathode wires 612, 614, 616, 618 secured to the first eye 110 and the second hook 220, and one through the anode and cathode wires 612, 614, 616, 618 secured to the second eye 120 and the first hook 210. This allows the flow of electricity to travel along the fasteners 10 without short circuiting.

Arrangements of the anode and cathode wires 612, 614, 616, and 618 that results in both anode wires 612, 614 being secured to the first hook 210 and second eye 120, or both anode wires 612, 614 being secured to the second hook 220 and the first eye 110, may result in a short circuiting of the electronic device 600 when a first fastener 10 is secured to a second fastener 20. Such an arrangement would result in an anode wire 612, 614 making electrical contact with another anode wire 612, 614, or a cathode wire 616, 618 making electrical contact with another cathode wire 616, 618 when one fastener 10 is secured to a second fastener 10 when the first fastener 10 and the second fastener 10 have the same arrangement of the anode and cathode wires 612, 614, 616, 618.

The cathode and anode wires 612, 614, 616, 618 may be secured to the fastener 10 by wrapping the cathode and anode wires 612, 614, 616, 618 around a portion of the wire 300 of the fastener 10. In some non-limiting embodiments, the cathode and anode wires 612, 614, 616, 618 may be secured to the fastener 10 by soldering, gluing, or taping the cathode and anode wires 612, 614, 616, 618 to a portion of the wire 300 of the fastener 10. The location in which the cathode and anode wires 612, 614, 616, 618 are secured to the wire 300 are referred to as contact points 310, 320, 330, and 340.

The cathode and anode wires 612, 614, 616, 618 may be structured and arranged to contact the cathode and anode wires 612, 614, 616, 618 of a second fastener 10 when the first fastener 10 is connected to the second fastener 10.

The first anode wire 612 or first cathode wire 616 is secured to the first hook contact point 310 on the first hook 210. The first hook contact point 310 may be on the central axis 500. The first hook contact point 310 may be at the location of the first hook 210 that is closest to the second tip 202 of the second end 200, such as the first hook second bend 325. The second tip 202 may be the point of the second end 200 of the fastener 10 that is farthest from the first end 100. The first hook contact point 310 may extend along the first hook second segment 214 and/or the first hook third segment 216. The first hook contact point 310 may surround a circumference of the wire 300 or may be on a portion of the circumference of the wire 300, such as the portion facing the first end 100.

The first anode wire 612 or first cathode wire 616, whichever is not secured to the first hook contact point 310, is secured to the second hook contact point 320 on the second hook 220. The second hook contact point 320 may be on the central axis 500. The second hook contact point 320 may be at the location of the second hook 220 that is closest to the second tip 202 of the second end 200, such as the second hook second bend 345. The second hook contact point 320 may extend along the second hook second segment 224 and/or the second hook third segment 226. The second hook contact point 320 may surround a circumference of the wire 300 or may be on a portion of the circumference of the wire 300, such as the portion facing the first end 100.

The second anode wire 614 or second cathode wire 618 is secured to the first eye contact point 330 on the first eye 110. The first eye contact point 330 may be on the central axis 500. The first eye contact point 330 may be at the location of the first eye 110 that is closest to the first tip 102 of the first end 100. The first eye contact point 330 may extend along the first eye perimeter 112 of the first eye 110. The first eye contact point 330 may surround a circumference of the wire 300 or may be on a portion of the circumference of the wire 300, such as the portion facing the second end 200.

The second anode wire 614 or second cathode wire 618, whichever is not secured to the first eye contact point 330, is secured to the second eye contact point 340 on the second eye 120. The second eye contact point 340 may be on the central axis 500. The second eye contact point 340 may be at the location of the second eye 120 that is closest to the first tip 102 of the first end 100. The second eye contact point 340 may extend along the second eye perimeter 122 of the second eye 120. The second eye contact point 340 may surround a circumference of the wire 300 or may be on a portion of the circumference of the wire 300, such as the portion facing the second end 200.

The contact points 310, 320, 330, 340 may be made of a conductive material, such as copper or aluminum. The contact points 310, 320, 330, 340 may be structured and arranged to allow electrical flow from the anode and cathode wires 612, 614, 616, 618 through the contact points 310, 320, 330, 340.

The wire 300 may have insulation on at least a portion of the wire outside surface 302. The insulation may prevent the wire 300 from conducting electricity. The insulation may be applied as a coating, such as by a dipping process or a spraying process. The insulation may be applied before the wire 300 is shaped into the fastener 10 or after the wire 300 is shaped into the fastener 10. The insulation may cover the entire outside surface 302 of the wire 300 or just areas of the wire 300 that are expected to come in contact with a cathode or anode wire 612, 614, 616, 618. The insulation may be structured and arranged to prevent the wire 300 of the fastener 10 from conducting electricity flowing through the cathode or anode wires 612, 614, 616, 618.

When two or more fasteners 10 are connected to each other, the cathode and anode wires 612, 614, 616, 618 of each fastener 10 are arranged the same for each fastener 10 such that each wire contacts the same contact point 310, 320, 330, 340 on their respective fastener 10. This allows the cathode wires 616, 618 of the first fastener 10 to come into electrical contact with the anode wires 612, 614 of the second fastener 10, and allows the anode wires 612, 614 of the first fastener 10 to come into electrical contact with the cathode wires 616, 618 of the second fastener 10. When two fasteners 10 are connected to each other, the first hook contact point 310 of the first fastener 10 may come into contact with the second eye contact point 340 of the second fastener 10, and the second hook contact point 320 of the first fastener may come into contact with the first eye contact point 330 of the second fastener 10.

Multiple fasteners 10 may be connected to each other in series, such that each contact point 310, 320, 330, 340 comes into contact with only one contact point 310, 320, 330, 340 of another fastener 10. In some non-limiting embodiments or aspects, some fasteners 10 may be connected to each other in parallel, such that one contact point 310, 320, 330, 340 may be in contact with two or more contact points 310, 320, 330, 340 of other fasteners 10. Multiple fasteners 10 may be connected in a combination of in series fasteners 10 and in parallel fasteners 10.

To provide adequate electrical connection between the contact points 310, 320, 330, 340, the distance between the first eye contact point 330 and the second eye contact point 340, referred to as the eye distance D_{E}, is the same as the distance between the first hook contact point 310 and the second hook contact point 320, referred to as the hook distance D_{H}. By maintaining the eye distance D_{E} and the hook distance D_{H} as being equal, it ensures that the hook contact points 310, 320 of a first fastener 10 can maintain contact with the eye contact points 330, 340 of the second fastener 10 when the two fasteners 10 are linked.

In some non-limiting embodiments or aspects, the hook distance D_{H} may be slightly less than the eye distance D_{E}. This slight decrease in distance causes the hooks 210, 220 to bend slightly in order to maintain contact with the eyes 110, 120 when a first fastener 10 is connected to a second fastener 10, thus creating a tension that aids in holding the hooks 210, 220 in place when connected with the eyes 110, 120.

In some non-limiting embodiments, the LED light 610 of the electronic unit 600 may be replaced by any other electronic device with two anode wires 612, 614 and two cathode wires 616, 618. The electronic device may be structured and arranged to allow occasional intermittent interruption of power to the electronic device such that if a contact point 310, 320, 330, 340 of a first fastener 10 becomes temporarily disconnected from the contact point 310, 320, 330, 340 of a second fastener 10, once the connection is remade, the electronic device is once again powered and functioning without additional action from any user of the device.

In some non-limiting embodiments or aspects, a power fastener 20 may be used, which is structured and arranged similar to the fastener 10, including the same first end 100 and second end 200 of the fastener 10, but may also include a power source 900, such as a battery. The power source 900 may be located between the first end 100 and the second end 200. The power source 900 may be electrically attached to the contact points 310, 320, 330, 340 of the first end 100 and/or the second end 200, such as by two anode wires and two cathode wires. The power source 900 may provide a 5V or 10V power supply to the power fastener 20. The power source 900 of the power fastener 20 is structured and arranged to allow coaxial power supply to flow along the fasteners 10.

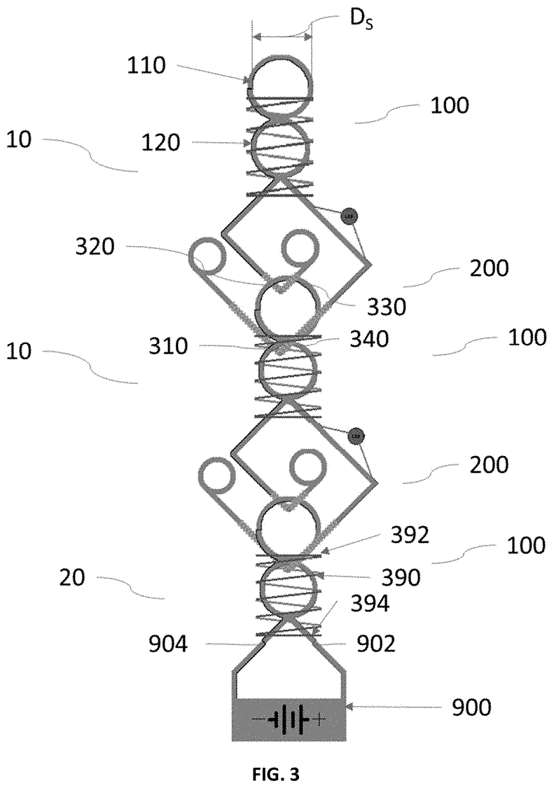

In some non-limiting embodiments, the power fastener 20 may not include a second end 200 such that the power source 900 is only electrically attached to the contact points 330, 340 of the first end 100, such as by one power source anode wire 902 and one power source cathode wire 904, as shown in FIG. 3. In some non-limiting embodiments, the power fastener 20 may not include a first end 100 such that the power source 900 is only electrically attached to the contact points 310, 320 of the second end 200, such as by one power source anode wire 902 and one power source cathode wire 904.

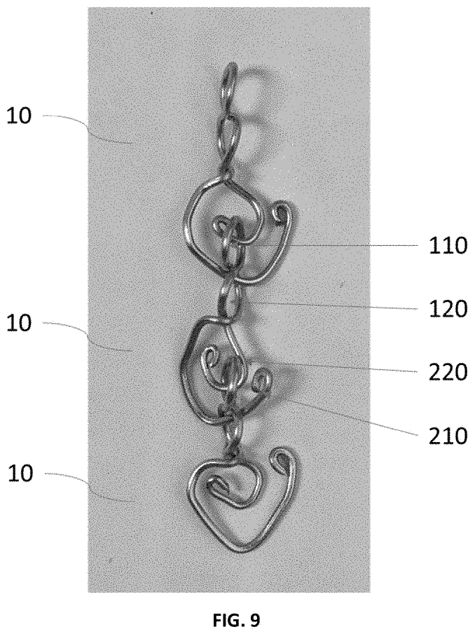

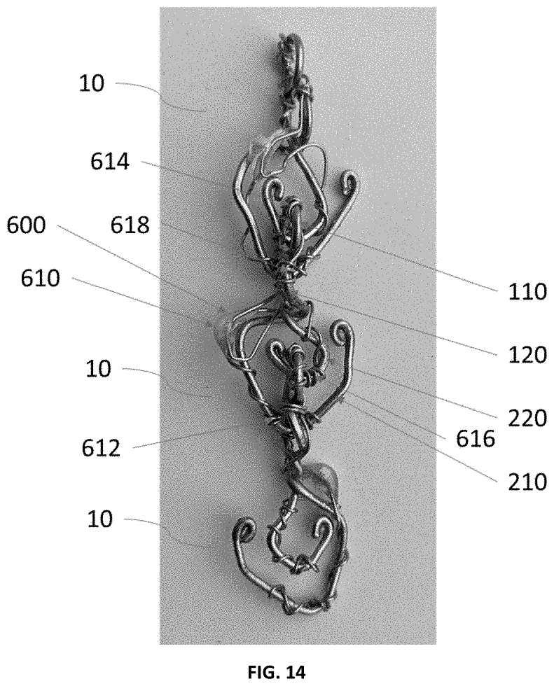

A chain of fasteners 10 may be arranged with one or more fasteners 10 including one or more power fasteners 20. Additional fasteners 10 may be attached to the first end 100 and/or the second end 200 of the power fastener 20. If more power is needed to electrify the electronics of the chain of fasteners 10, additional power fasteners 20 may be included in the chain. Two power fasteners 20 may be adjacent to each other, or may be separated by one or more fasteners 10. Shown in FIG. 9 is a chain of fasteners 10 without electronic units 600, while FIG. 14 shows a chain of fasteners 10 with electronic units 600.

The chain of fasteners 10 may form a circular chain. If a circular chain of fasteners 10 is disconnected, becoming a linear chain of fasteners 10, all of the fasteners 10 will remain powered by the power fastener 20, regardless of whether the fasteners 10 are connected to the first end 100 or the second end 200 of the power fastener 20. New fasteners 10 may be attached to either end of the linear chain of fasteners 10 or circular chain of fasteners 10 and may be instantly powered by the at least one power fastener 20 of the chain once the contact points 310, 320, 330, 340 of the new fastener 10 makes electrical contact with the contact points 310, 320, 330, 340 of a fastener 10 in the chain.

In some non-limiting embodiments or aspects, the fasteners 10 may be used as accessories, such as a bracelet or necklace. The fasteners 10 with LED lights 610 may provide a user with an accessory that lights up when being worn, and can be adjusted by including new fasteners 10, such as fasteners 10 with different colored LED lights 610, without significant effort from the user. Additional fasteners 10 with different electronic devices can also be added or removed from the accessory as desired by the user.

In some non-limiting embodiments, the fastener 10 may also include a spring 390, as shown in FIG. 3, to aid in securing the first fastener 10 to the second fastener 10. The spring 390 may have a spring inner diameter D_{S} that is less than the outer diameter of the first eye 110, which is equal to the inner diameter of the first eye D_{E1} added to twice the wire diameter D_{W}, but greater than the outer diameter of the second eye 120, which is equal to the inner diameter of the second eye D_{E2} added to twice the wire diameter D_{W}.

When the first fastener 10 is connected to the second fastener 10, the spring 390 will surround a portion of the first end 100 of the first fastener 10. An upper portion 392 of the spring 390 may come in contact with the first hook 210 of the second fastener 10 while a lower portion 394 of the spring 390 may come in contact with the second end 200 of the first fastener 10 such that the spring 390 is in tension, applying a downward force to the first fastener 10 and applying an upward force to the second fastener 10.

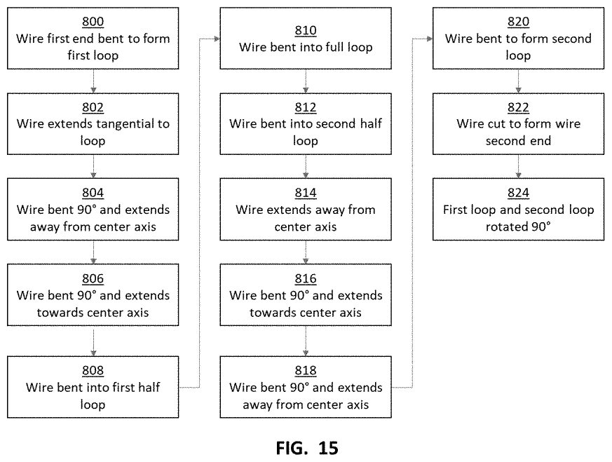

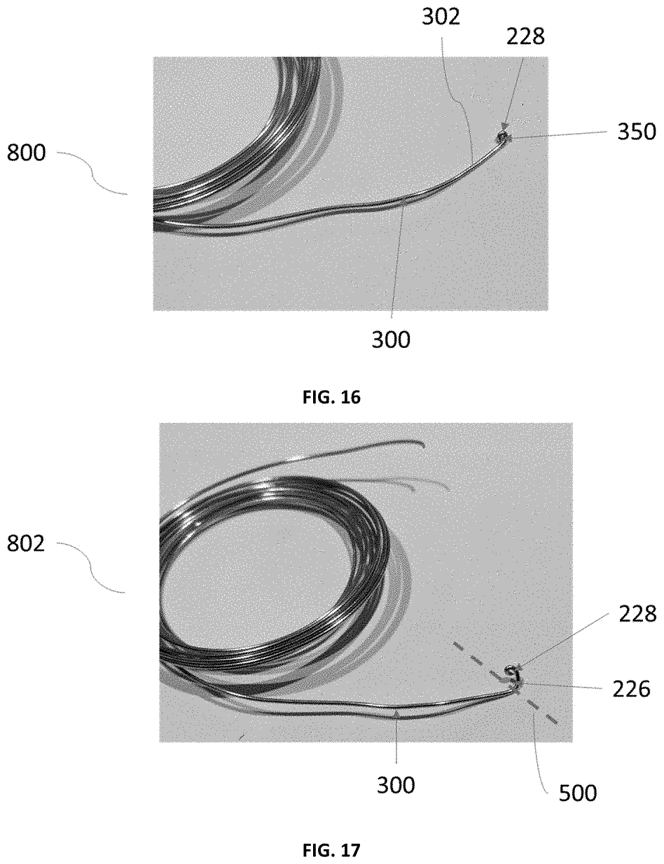

As shown in FIG. 15, the fastener 10 may be formed by bending a single wire 300 into shape. The fastener 10 may be formed into shape by mechanical means, such as by hand or by machine, by the steps shown in Steps 800-824. The steps of FIG. 15 are illustrated in FIGS. 16-28. In some non-limiting embodiments, the final shape of the wire may be formed by a mold.

In Step 800, shown in FIG. 16, the wire first end 350 may be bent into the shape of a loop such that the wire first end 350 may bend back towards the wire 300 or come in contact with the wire 300. The loop may form the second hook loop 228 of the second hook 220.

In Step 802, shown in FIG. 17, the wire 300 may then extend tangential to the second hook loop 228 in a straight line forming the second hook third segment 226. The wire 300 may approach the center axis 500 at a 45° angle.

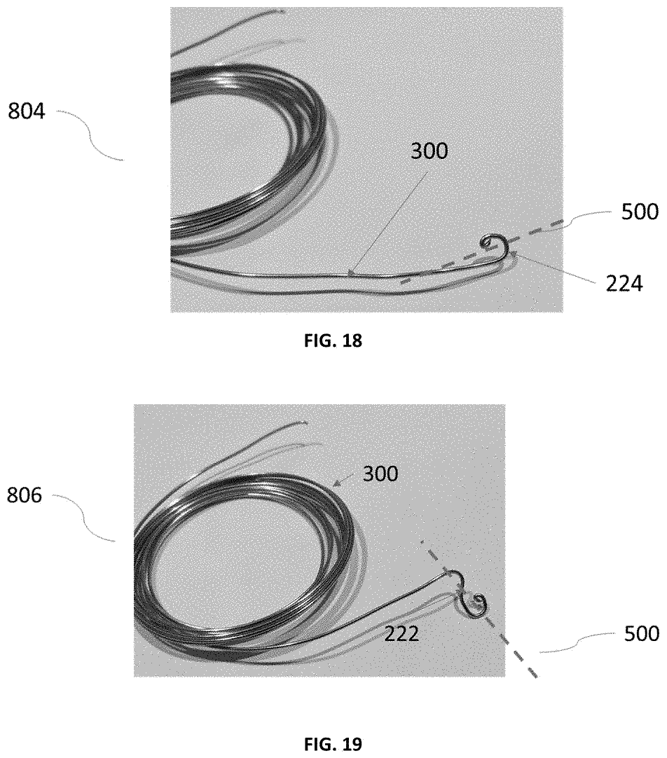

In Step 804, shown in FIG. 18, at the center axis 500, the wire 300 may be bent 90° and may then extend in a straight line away from the center axis 500 at a 45° angle, forming the second hook second segment 224.

In Step 806, shown in FIG. 19, the wire 300 may then be bent 90° towards the center axis 500, extending in a straight line to the center axis 500, forming the second hook first segment 222.

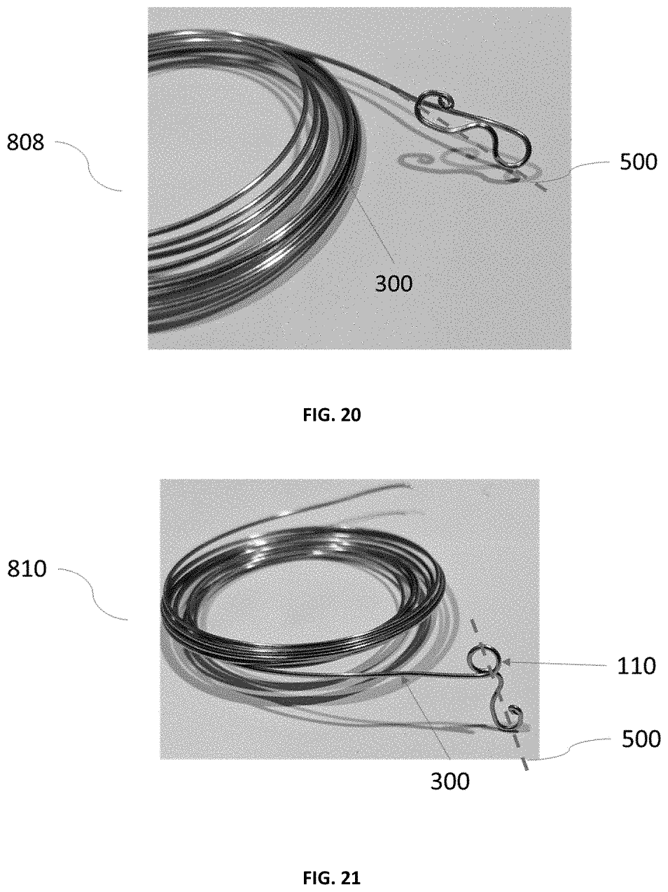

In Step 808, shown in FIG. 20, the wire 300 may be bent into a first half loop such that the first end of the half loop and the second end of the half loop both align with the center axis 500.

In Step 810, shown in FIG. 21, the wire 300 may be bent into a full loop such that the top of the full loop and the bottom of the full loop lies on the center axis 500, forming the first eye 110. The wire 300 may come in contact with itself at the bottom of the full loop.

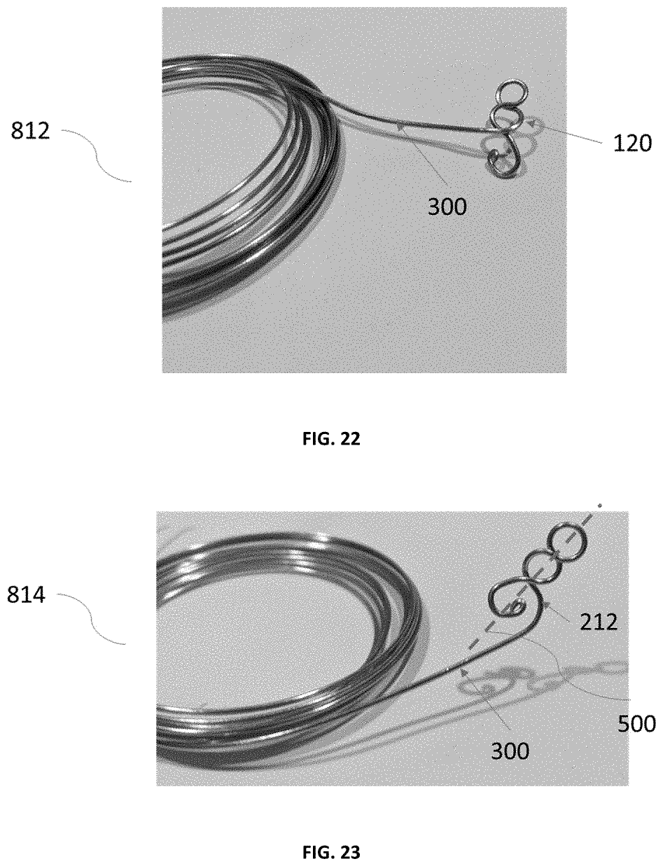

In Step 812, shown in FIG. 22, the wire 300 may be bent into a second half loop, such that the first half loop and the second half loop for a full loop, thus forming the second eye 120. The wire 300 may come in contact with itself at the bottom of the first half loop and the bottom of the second half loop.

In Step 814, shown in FIG. 23, the wire 300 may be bent to extend away from the center axis 500 in a straight line at a 45° angle from the center axis 500, forming the first hook first segment 212.

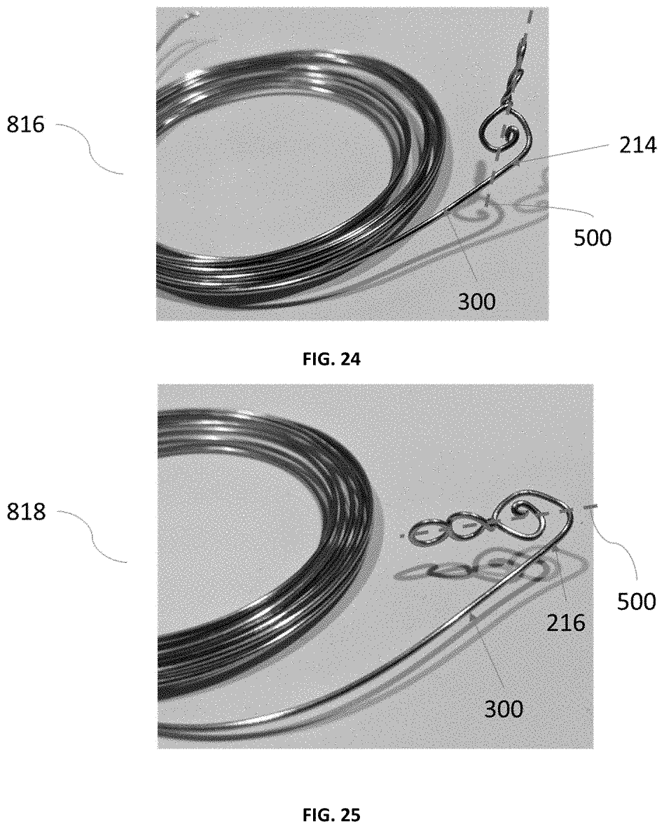

In Step 816, shown in FIG. 24, the wire 300 may be bent 90° and may extend in a straight line at a 45° angle from the center axis 500 towards the center axis 500, forming the first hook second segment 214.

In Step 818, shown in FIG. 25, the wire 300 may be bent 90° and may extend in a straight line at a 45° angle from the center axis 500, moving away from the center axis 500. This may form the first hook third segment 216.

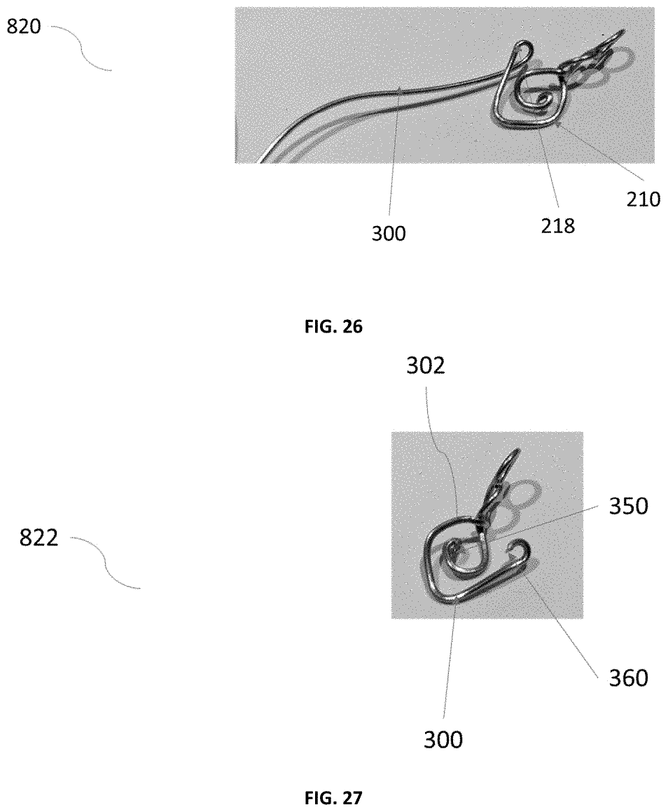

In Step 820, shown in FIG. 26, the wire 300 may bend back towards the wire 300 or come in contact with the wire 300. The loop may form the first hook loop 218 of the first hook 210.

In Step 822, shown in FIG. 27, the wire 300 may be cut at the end of the loop, forming the wire second end 360. In some non-limiting embodiments or aspects, the length of the wire 300 may be cut at a predetermined length prior to Step 800 such that the wire 300 includes the wire first end 350 and the wire second end 360 at the beginning of the shaping process.

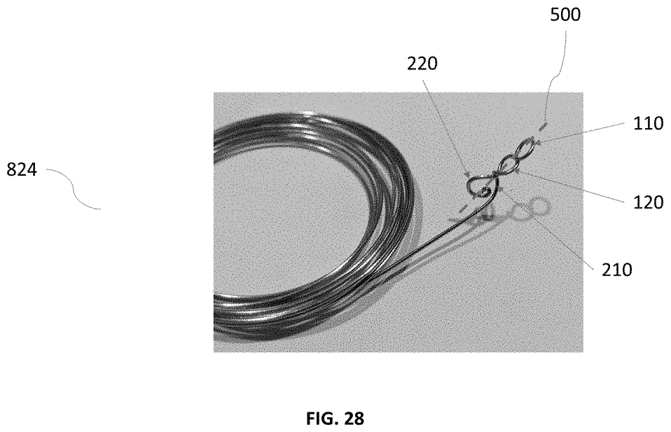

In Step 824, shown in FIG. 28, the first loop (i.e., first eye 110), and second loop (i.e., second eye 120) may be rotated about 90° such that the centers of the first eye 110 and second eye 120 may remain within the center axis 500, resulting in the first eye 110 and second eye 120 being in a plane that is substantially perpendicular to the plane of the first hook 210 and second hook 220. Step 824 may be performed at a point after the formation of the second loop in Step 812. For example, Step 820 may occur between Steps 812 and 814.

In some non-limiting embodiments, Steps 800-822 may be performed such that the first hook 210, second hook 220, first eye 110, and second eye 120 remain within the same plane.

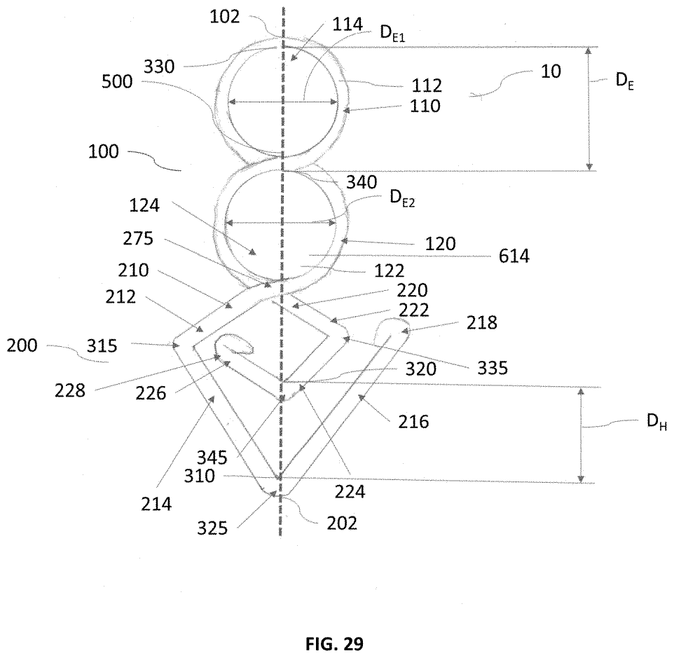

Shown in FIG. 29 is an example dual hook and eye fastener 1010 in a non-limiting embodiment. The example fastener 1010 includes an example first end 1100 and example second end 1200, which may be the same or similar to the first end 100 and second end 200, respectively. The example first end 1100 and the example second end 1200 may be centered around a center axis 1500.

The example first end 1100 may include an example first eye 1110 that is the same or similar to the first eye 100, including an example first eye perimeter 1112 and a example first eye opening 1114. The inner radius of the example first eye 1110 may be 5 mm.

The example first end 1100 may also include an example second eye 1120 that is the same or similar to the second eye 200, including an example second eye perimeter 1122 and an example second eye opening 1124. The inner radius of the example second eye 1120 may be 4 mm.

The example second end 1200 may include an example first hook 1210 that is the same or similar to the first hook 210, including an example first hook first segment 1212, example first hook second segment 1214, example first hook third segment 1216, and example first hook loop 1218. The example first hook first segment 1212 may extend from the example center point 1275 and be 7 mm long, the example first hook second segment 1214 may be 10 mm long, and the example first hook third segment 1216 may be 14 mm long. The example first hook first segment 1212 and the example first hook second segment 1214 may be separated by an example first hook first bend 1315, which may be at an angle of 90°. The example first hook second segment 1214 and the example first hook third segment 1216 may be separated by an example first hook second bend 1325, which may be at an angle of 80°.

The example second end 1200 may include an example second hook 1220 that is the same or similar to the second hook 220, including an example second hook first segment 1222, example second hook second segment 1224, example second hook third segment 1226, and example second hook loop 1228. The example second hook first segment 1222 may extend from the example center point 1275 and be 5 mm long, the example second hook second segment 1224 may be 5 mm long, and the example second hook third segment 1226 may be 5 mm long. The example second hook first segment 1222 and the example second hook second segment 1224 may be separated by an example second hook first bend 1335, which may be at an angle of 90°. The example second hook second segment 1224 and the example second hook third segment 1226 may be separated by an example second hook second bend 1345, which may be at an angle of 100°.

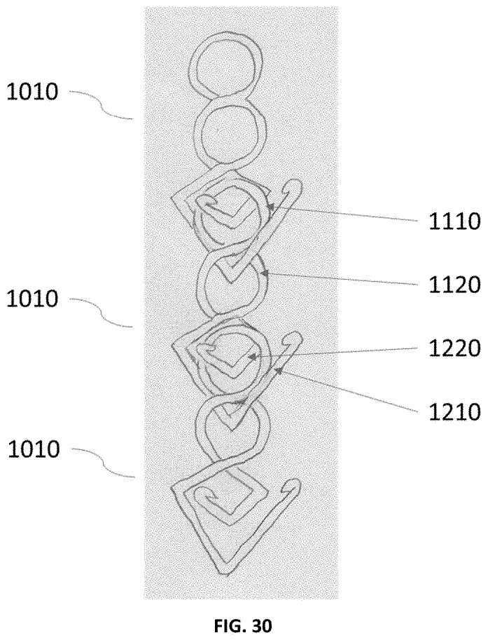

The example contact points 1310, 1320, 1330, 1340 may be the same or similar to the contact points 310, 320, 330, 340. The example first contact point 1310 may be located at the first hook first bend 1315. The example second contact point 1320 may be located at the second hook first bend 1325. The example third contact point 1330 may be on the example first eye perimeter 1112. The example fourth contact point 1340 may be on the example second eye perimeter 1122. As shown in FIG. 30 multiple of the example fasteners 1010 may be secured to each other in a chain.

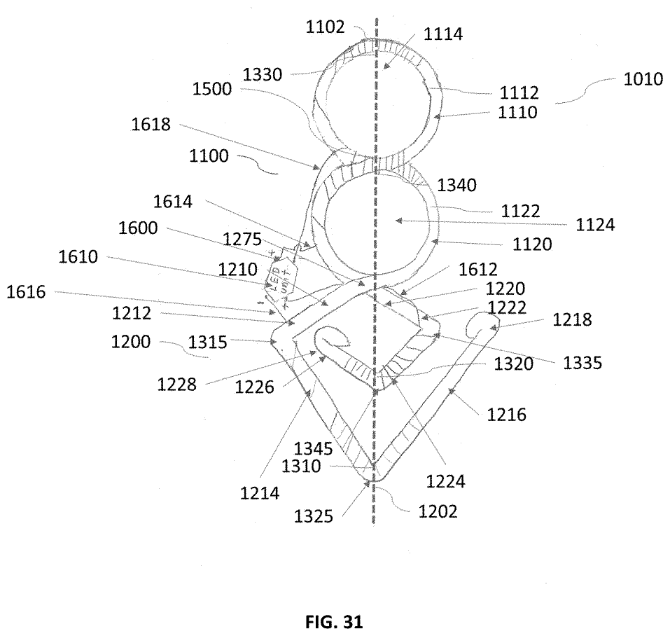

An example electronic unit 1600 may also be secured to the example dual hook and eye fastener 1010, as shown in FIG. 31. The example electronic unit may be the same or similar to the electronic unit 600, including an example LED light 1610, an example first anode wire 1612, an example second anode wire 1614, an example first cathode wire 1616, and an example second cathode wire 1618. The example first anode wire 1612 may be secured to the example second contact point 1320, the example second anode wire may be secured to the example second anode 1614 wire may be secured to the example fourth contact point 1340, the example first cathode wire 1616 is secured to the example first contact point 1310, and the example second cathode wire 1618 is secured to the example third contact point 1330.

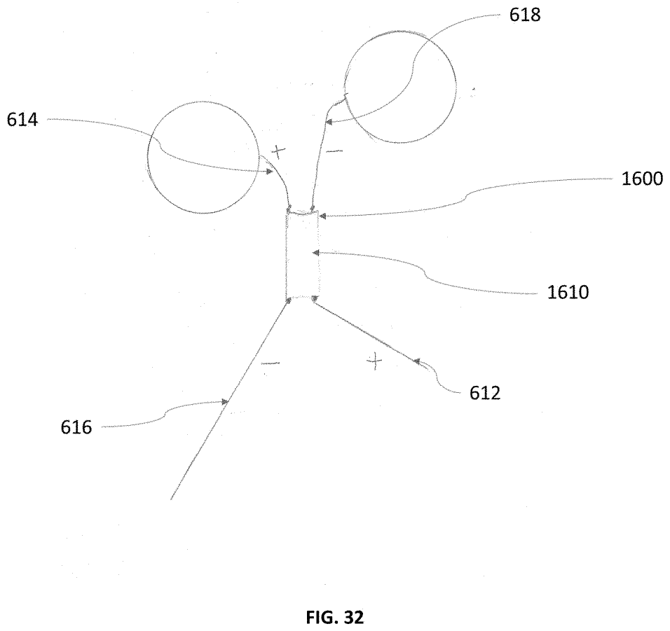

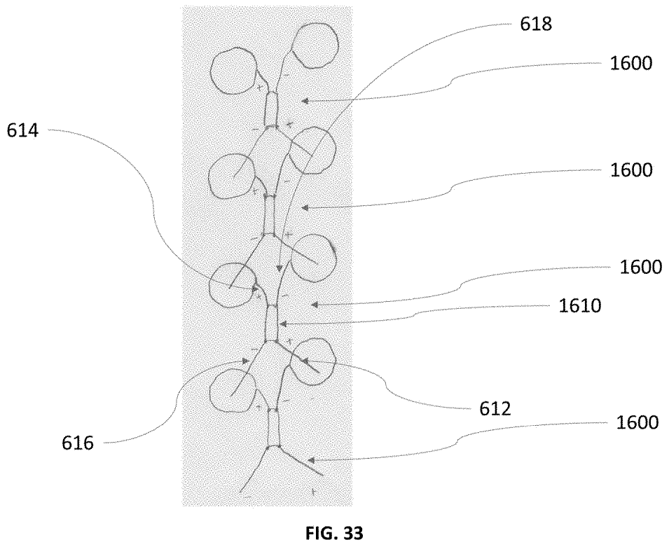

Shown in FIG. 32 is a diagram of the example electronic unit 1600 separate from the example fastener 1010, and shown in FIG. 33 is an example diagram of how multiple example electronic units 1600 would be electronically connected in series.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A dual hook and eye fastener comprising:
a first end and a second end opposite the first end;
a first eye and a second eye located adjacent the first end, the first eye being located farther from the second end than the second eye; and
a first hook and a second hook located adjacent the second end, the first hook being located farther from the first end than the second hook.

2. The dual hook and eye fastener of claim 1, wherein the first hook is structured and arranged to be connected to a second dual hook and eye fastener by inserting the first hook through the second eye of the second dual hook and eye fastener.

3. The dual hook and eye fastener of claim 2, wherein the second hook is structured and arranged to be inserted through a first eye of the second dual hook and eye fastener.

4. The dual hook and eye fastener of claim 1, wherein the first eye and the second eye are oriented substantially within a first plane and the first hook and the second hook are oriented substantially within a second plane.

5. The dual hook and eye fastener of claim 4, wherein the first plane is oriented substantially perpendicular to the second plane.

6. The dual hook and eye fastener of claim 1, wherein the first eye and the second eye are centered along a central axis.

7. The dual hook and eye fastener of claim 6, wherein a body of the first hook extends in a first direction transverse to the central axis and a body of the second hook extends in a second direction transverse to the central axis, the first direction being opposite of the second direction.

8. The dual hook and eye fastener of claim 1, further comprising a spring at least partially surrounding the second eye, the spring comprising a spring diameter being wider than a diameter of the second eye and thinner than a diameter of the first eye.

9. The dual hook and eye fastener of claim 1, wherein the first hook surrounds at least a portion of the second hook.

10. The dual hook and eye fastener of claim 1, wherein the first hook, second hook, first eye, and second eye are formed from a single section of wire.

11. The dual hook and eye fastener of claim 1, further comprising an electronic unit secured to the first hook, the second hook, the first eye, and the second eye, the electronic unit comprising:
an LED light;
a first anode wire;
a second anode wire;
a first cathode wire; and
a second cathode wire, wherein
the first anode wire is secured to the first hook at a first hook contact point;
the second anode wire is secured to the second eye at a second eye contact point;
the first cathode wire is secured to the second hook at a second hook contact point; and
the second cathode wire is secured to the first eye at a first eye contact point.

12. The dual hook and eye fastener of claim 11, wherein an eye height H_{E}, taken as the distance between the first eye contact point and the second eye contact, is equal to a hook height H_{H}, taken as a distance between the first hook contact point and the second hook contact point.

13. The dual hook and eye fastener of claim 12, wherein:
the first eye contact point is located on an inner circumference of the first eye furthest from the second end;
the second eye contact point is located on an inner circumference of the second eye furthest from the second end;
the first hook contact point is located on an inner surface of the first hook furthest from the first end; and
the second hook contact point is located on an inner surface of the second hook furthest from the first end.

14. The dual hook and eye fastener of claim 1, further comprising an electronic unit secured to the first hook, the second hook, the first eye, and the second eye, the electronic unit comprising:
an LED light;
a second anode wire;
a first cathode wire; and
a second cathode wire, wherein
the first anode wire is secured to the second hook at a second hook contact point;
the second anode wire is secured to the first eye at a first eye contact point;
the first cathode wire is secured to the first hook at a first hook contact point; and
the second cathode wire is secured to the second eye at a second eye contact point.

15. The dual hook and eye fastener of claim 14, wherein an eye height H_{E}, taken as the distance between the first eye contact point and the second eye contact, is equal to a hook height H_{H}, taken as a distance between the first hook contact point and the second hook contact point.

16. The dual hook and eye fastener of claim 15, wherein:
the first eye contact point is located on an inner circumference of the first eye furthest from the second end;
the second eye contact point is located on an inner circumference of the second eye furthest from the second end;
the first hook contact point is located on an inner surface of the first hook furthest from the first end; and
the second hook contact point is located on an inner surface of the second hook furthest from the first end.

17. A chain of dual hook and eye fasteners, the chain comprising a first dual hook and eye fastener and a second dual hook and eye fastener, each of the first dual hook and eye fastener and the second dual hook and eye fastener comprising:
a first end and a second end opposite the first end;
a first eye and a second eye located at the first end, the first eye being located farther from the second end than the second eye; and
a first hook and a second hook located at the second end, the first hook being located farther from the first end than the second hook, wherein:
the first end of the first dual hook and eye fastener is secured to the second end of the second dual hook and eye fastener.

18. The chain of dual hook and eye fasteners of claim 17, at least one dual hook and eye fastener further comprising an electronic unit secured to the first hook, the second hook, the first eye, and the second eye, the electronic unit comprising:
an LED light;
a first anode wire;
a second anode wire;
a first cathode wire; and
a second cathode wire, wherein:
the first anode wire is secured to the first hook at a first hook contact point;
the second anode wire is secured to the second eye at a second eye contact point;
the first cathode wire is secured to the second hook at a second hook contact point; and
the second cathode wire is secured to the first eye at a first eye contact point.

19. The chain of dual hook and eye fasteners of claim 18, further comprising a power fastener, the power fastener comprising:
at least one of the first end or the second end;
a power supply;
a cathode wire; and
an anode wire, wherein:
the power supply is electrically connected to the cathode wire and the anode wire;
the cathode wire is secured to the second hook at a second hook contact point of the power fastener or the first eye at a first eye contact point of the power fastener; and
the anode wire is secured to the first hook at a first hook contact point of the power fastener or the second eye at a second eye contact point of the power fastener.

20. The chain of dual hook and eye fasteners of claim 19, wherein the power fastener comprises both the first end and the second end.

21. The chain of dual hook and eye fasteners of claim 17, the first dual hook and eye fastener further comprising a spring at least partially surrounding the second eye of the first dual hook and eye, the spring comprising a spring diameter being wider than a diameter of the second eye of the first dual hook and eye and thinner than a diameter of the first eye of the first dual hook and eye.

22. The chain of dual hook and eye fasteners of claim 17, wherein the chain of dual hook and eye fasteners comprises at least three dual hook and eye fasteners secured to each other to form a loop.

23. The chain of dual hook and eye fasteners of claim 15, wherein the first eye and the second eye of the first dual hook and eye fastener are oriented within a first plane, and the first hook and the second hook of the first dual hook and eye fastener are oriented in a second plane, the first plane being perpendicular to the second plane.
